(19) United States
(12) Patent Application Publication
(10) Pub. No.: US 2013/0252461 A1
(43) Pub. Date: Sep. 26, 2013

(54) Plug and Socket Connector Part For a Medical Device or Instrument

(71) Applicant: ERBE ELEKTROMEDIZIN GMBH, Tuebingen (DE)

(72) Inventor: Stefan Gross, Tuebingen (DE)

(73) Assignee: ERBE ELEKTROMEDIZIN GMBH, Tuebingen (DE)

(21) Appl. No.: 13/801,440

(22) Filed: Mar. 13, 2013

(30) Foreign Application Priority Data
Mar. 23, 2012 (EP) 12161065.3

(51) Int. Cl. H01R 13/00

(52) U.S. Cl. CPC H01R 13/005
USPC 439/577

(57) ABSTRACT

A plug and socket connector system in accordance with the invention for use, in particular, in medical technology comprises a plug 16 and a socket 18, wherein each of the two comprises at least one fluid connector element 24, 33. The fluid connector elements 24, 33 are provided with electrical contact arrangements 48, 51, thus providing a space-saving, robust and safe system.

### RELATED APPLICATIONS(S)

This application claims the benefit of European Patent Application No. 12161065.3, filed Mar. 23, 2012, the contents of which are incorporated by reference as if fully rewritten herein.

### TECHNICAL FIELD

The invention relates to a plug and socket connector part for a medical device or a medical instrument.

### BACKGROUND

A few medical instruments are designed in such a manner that they need to be supplied with at least one fluid, as well as with at least one electrical signal. The fluid may be a gas, a fluid in supercritical state, an aerosol, or a combination thereof. The electrical signal may be an information-carrying signal such as, e.g., a switching signal, a bit sequence or the like, or also a power signal such as, e.g., an RF voltage or an RF current that is used to achieve an effect on a biological tissue.

Publication DE 6 9126 721 T2 discloses an example of a medical instrument that requires an electrical supply as well as a fluid supply. The instrument comprises a flexible connecting hose that initially leads to an electric plug and, from there, to a fluid connection.

It is the object to provide a plug and socket connector part disposed for setting up a plug and socket connector system with which fluid media as well as electrical signals can be conveyed in a simple and safe manner.

### SUMMARY

The plug and socket connector part in one example comprises at least one fluid connector element that—if it is the male connector—is configured as a plug pin and—if it is the female connector—is configured as a socket. The plug pin may be any oblong part consisting of metal or of another material, e.g., a plastic material, having a round or non-round, e.g., polygonal, cross-section, said part being essentially straight or elongated. A female connector may be understood to be any element that circumscribes an oblong receiving space that is open on at least one side, into which receiving space a plug pin can be inserted. The receiving space has a cross-section that may be round or non-round, e.g., polygonal. Preferably, the receiving space is straight and its cross-section is unchanged along its length, i.e., it has a cylindrical configuration, for example.

The plug and socket connector part comprises at least one fluid channel communicating with an opening of said plug and socket connector part. The opening is disposed for the supply or removal of fluid media such as, e.g., fluids, gases, supercritical fluids, aerosols, smoke, or the like. A fluid supply line and/or a fluid removal line are connected to the fluid channel.

In addition, the plug and socket connector part in accordance with the invention comprises an electrical contact arrangement. Preferably, this arrangement is located at one end of the fluid connector element, i.e., in the case of the plug pin, on the free end of said element and, i.e., in the case of the female connector, to its inside end or the bottom. Considering this basic connector, it is successful with a single pairing of two matching connector parts to convey a fluid medium as well as an electric current. The fluid, as well as the current, are directly conveyed on the fluid connector that bears the electrical contact arrangement. Consequently, no electrical contacts outside the fluid connector contacts are required in the case of plug or a socket constructed in the aforementioned manner when one or more of the mentioned combined connector elements are used. Loose contacts or other unreliable contacts can thus be precluded in a simple manner. Likewise, it is possible, in this manner, to design relatively slim, easy to use plugs.

In a preferred embodiment, the electrical contact arrangement and the plug element are arranged so as to be coaxial relative to each other. As a result of this, the joining of the respective plug and socket connector parts becomes particularly easy. The plug pin of the plug can be radially guided in the female connector of the socket, wherein the guiding promotes a joining of the contact arrangements of the plug and the socket. Consequently, sensitive electrical contacts are handled with care. Tight tolerances can be used, without there being the risk of damage in case of inappropriate handling. Both fluid connector elements form a linear guide arrangement for the two electrical contact arrangements.

It is pointed out that the electrical contact arrangement may be configured as a monopolar or a multipolar embodiment, irrespective of the specific embodiment. For example, it may be configured as a monopolar contact pin. Alternatively, it may be configured as a non-conductive pin that has, applied to its surface, several spaced apart contact strips that are insulated relative to each other and extend axially in circumferential direction in order to form a multipolar plug pin. Corresponding thereto, the contact arrangement—if it is configured as a female contact connector—may be configured as a monopolar female connector that is electrically conductive at least on its inside or as a non-conductive female connector comprising several axially extending contacts that are spaced apart in circumferential direction.

Preferably, the electrical contact arrangement and the plug element are electrically connected to each other, irrespective of the remaining design of the plug and socket connector arrangement. As a result of this, the plug element itself may be used as an electrical conductor, thus contributing to the simplicity of the design and facilitating the routing of lines.

Independent of the remaining design of the plug and socket connector arrangement, it is also possible, alternatively, to arrange the electrical contact arrangement and the plug element so that they are electrically insulated from each other. This can be helpful when high voltages requiring good insulation are used in order to ensure the necessary protection against accidental contact.

The electrical separation of the contact arrangement from the plug element may also provide other advantages, e.g., in view of the transmission of electrical information-carrying signals and their noise immunity.

It is possible to directly connect an electrical line to the contact arrangement and/or via the plug element. The direction connection of the line with the electrical contact arrangement is especially useful if the plug element itself is not conductive. Other than that, the two options may be used independently of any other conditions of the plug and socket connector arrangement.

If the electrical contact arrangement is configured as a female contact connector, said connector may be rigid or, alternatively, comprise one or more spring contacts. Accordingly, the contact pin may comprise one or more spring contacts or it—in turn—may be rigid. Consequently, preferably at least one spring contact is effective between the two contact arrangements that are configured as a female contact connector and as a contact pin. Preferably, a self-centering spring contact arrangement is preferred, said arrangement comprising at least two, preferable three or more, spring contacts along the circumference of the contact pin and/or the female contact connector.

Alternatively, the electrical contact arrangement may comprise an axially oriented contact surface. This contact surface may be provided on the female contact connector, e.g., at its bottom, or on an axially oriented contact pin, e.g., in the form of its face surface. The contact surface may be a flat surface or a curved surface displaying greater or smaller curvature, a tip, or the like. The axial orientation of this contact surface is understood to mean that the surface is essentially oriented in a direction transverse to the axial direction of the female contact connector and/or the contact pin. In doing so, the axial direction is that direction in which the plug pin and the female connector can be brought into or out of engagement with each other.

The contact pin may be rigidly or resiliently supported. In the case of a resilient support, said pin is preferably supported so as to be axially resilient in order to, e.g., have its face surface reach a corresponding contact surface of the female contact connector. Preferably, the contact pin is held in the plug element in a pretensioned manner. Pretensioning may be accomplished by a spring. By pretensioning, it is possible—at the same time—to adjust the contact pressure on the electrical contact surface within narrow limits.

The fluid channel extends toward the opening, wherein said channel—communicating with the opening—preferably extends in a direction transverse to the axial direction of the plug element. Preferably, a gasket is arranged in axial direction both on the upstream side and on the downstream side of the opening. In doing so, it is possible to achieve a high pressure resistance of the plug and socket connection. Suitable gaskets are O-rings or also other sealing elements.

### BRIEF DESCRIPTION OF THE DRAWINGS

Advantageous embodiments of the plug and socket connector arrangement can be inferred from the drawings. They show in

FIG. 1 a schematic illustration of a medical device and a medical instrument with an associate plug and socket connector;

FIG. 2 a schematic sectional perspective illustration of a detail of a line that leads from the medical device to the medical instrument;

FIG. 3 a side view, partially schematized, of the separated plug and socket connector in accordance with FIG. 1;

FIGS. 4-7 sectional, schematized illustrations of plugged-in plug and socket connector arrangements for producing an electrical contact and a fluid connection; and

FIG. 8 a sectional schematic illustration of a modified embodiment of a plugged-in plug and socket arrangement for producing an electrical contact and a fluid connection.

### DETAILED DESCRIPTION

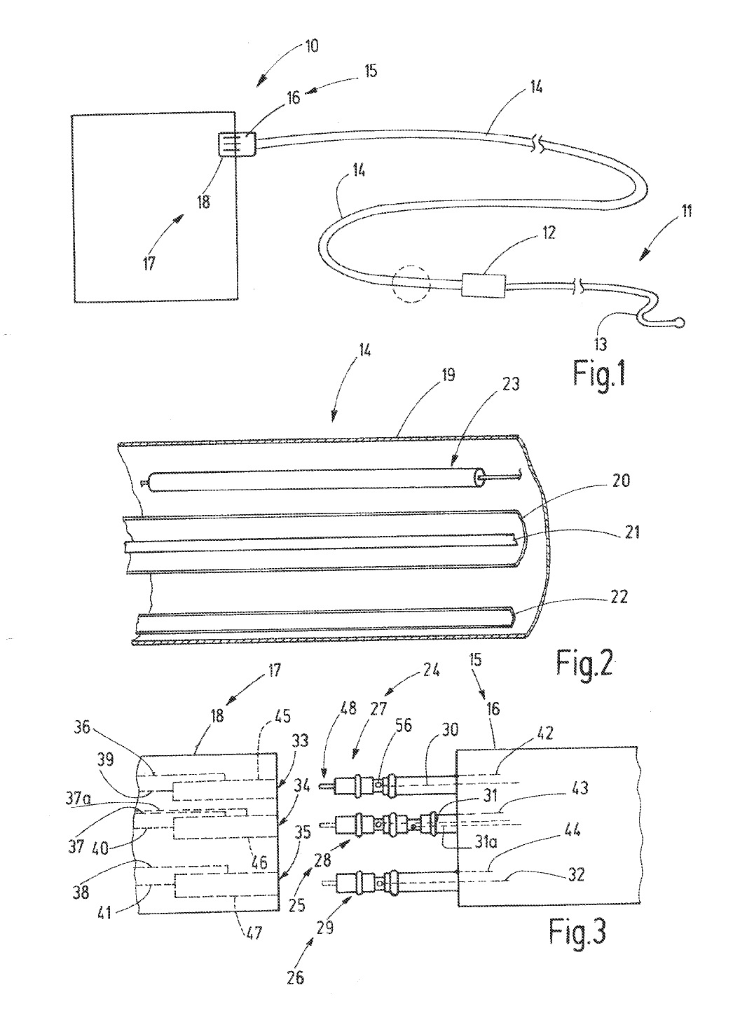

FIG. 1 shows a medical device 10 that is disposed for supplying a surgical instrument 11. The latter comprises a grip part 12 that is used to guide and/or control a part 13 that is to be brought into contact with the patient. The grip part 12 is connected to the device 10 via a line 14, through which line the desired fluid medium for supplying part 13, as well as electrical voltages and/or currents, can be conveyed. In doing so, the line 14 connects the grip part 12 with a plug and socket connector part 15 that is configured as a plug 16. On the side of the device 10, the latter is associated with an additional plug and socket connector part 17 that is configured as a socket 18. The plug and socket connector parts 15, 17 together form a connector device for transferring a fluid medium and for transferring electrical signals. These may be power signals, information-carrying signals or mixed forms thereof. FIG. 2 shows the line 14 that contains a jacket sheath 19, one or more inner tubes or hoses 20, 21, 22 and/or one or more electrically exposed or insulated lines 23.

FIG. 3 shows the plug and socket connector parts 15, 17 separately. The plug and socket connector part 15 is a combined plug and socket connector part comprising at least one, preferably several, fluid connector elements 24, 25, 26 that are depicted here as plug pins 27-29, for example. At least one of the plug pins 27-29 is a combined plug pin that acts as a fluid connection and also as an electrical connection. As illustrated, the fluid connector elements 24-26 may be arranged next to each other in parallel orientation at a lateral distance from each other. In doing so, they may be positioned in a straight line or also a curved line at equal or varying distances, for example, in order to ensure that the plug and socket connector part 15 can be joined together with the plug and socket connector part 17 in only one selected position.

The fluid connector elements 24-26 comprise at least one fluid channel 30, 32 or also several fluid channels 31, 31a as illustrated with the example of the fluid connector element 25 of FIG. 3. However, it is also possible to provide all of the fluid connector elements 24-26 with only one fluid channel each. Furthermore, individual fluid connector elements may be without a fluid channel or also be provided with more than two fluid channels. Any combination of the mentioned fluid connector elements with one another is possible.

In FIG. 3, the fluid connector elements 24-26 of the plug and socket connector part 15 are allocated to socket-type fluid connector elements 33-35 of the plug and socket connector part 17, said fluid connector elements 33-35 being shown in dashed lines, and their positions and lateral distances from each other, as well as the remaining arrangement corresponding to that of the fluid connector elements 24-26. At least one, preferably more or all, of the fluid connector elements 33-35 communicate with the fluid channels 36, 37, 37a, 38. In addition, at least one of the fluid connector elements 33-35, preferable more or all of them, are connected to an electrical line 39, 40, and/or 41. Accordingly, the plug and socket connector part 15 comprises at least one, preferably two or several electrical lines 42, 43, 44 that are connected to one or more of the fluid connector elements 24-26.

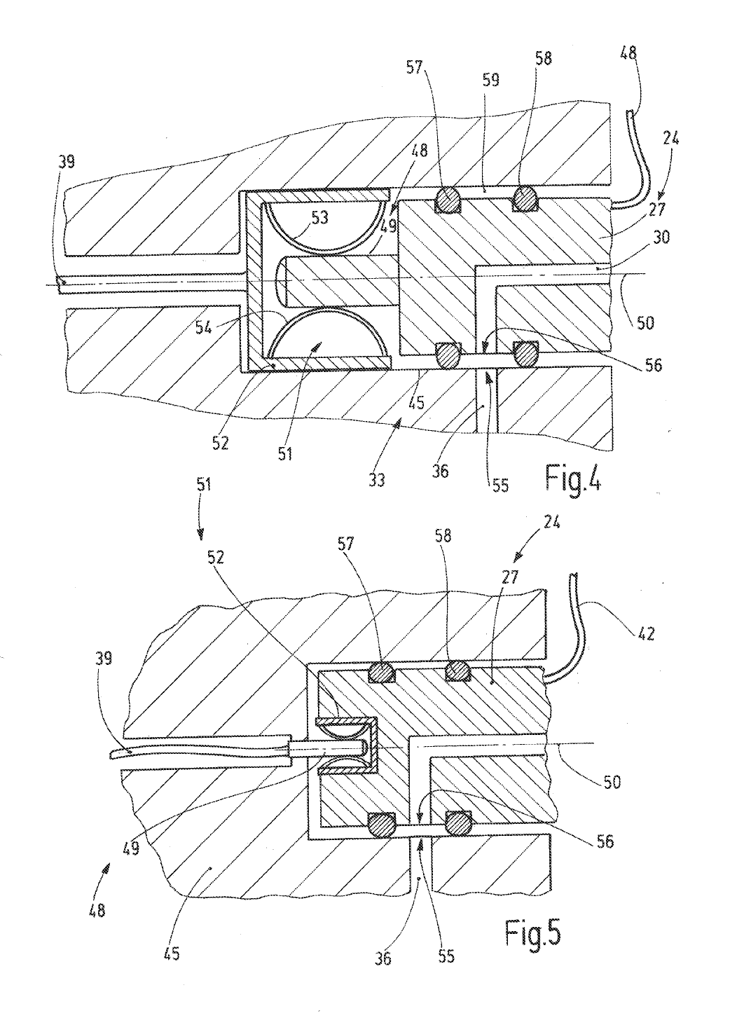

FIG. 4 shows one potential embodiment of the fluid connector element 24 and the associate fluid connector element 33 of FIG. 3. The fluid connector elements 24, 33 shown in FIG. 4 again comprise the plug pin 27 and a female connector 45. Accordingly, referring to FIG. 3, the fluid connector elements 34 and 35, are the female connectors 46, 47.

As illustrated, the fluid connector element 24 preferably is configured as an approximately cylindrical body and provided with an electrical contact arrangement 48 on its face end. Said contact arrangement is a contact pin 49, for example. Preferably, the contact pin 49 is arranged coaxially with the fluid connector element 24, this being indicated by the common axis 50 in FIG. 4. The axis 50 extends along the axial direction of the connector element 24 and parallel to the direction, in which the connector elements 24, 33 can be plugged together or pulled apart.

As shown, the contact pin 49 can be configured as a cylindrical pin or have a shape different therefrom, for example, the shape of a mushroom head, a barrel, or the like, for example, in order to achieve a haptic engagement effect.

Preferably, the contact pin 49 has a substantially smaller diameter than the plug pin 27. However, it is pointed out that the contact pin 49 may also have the same diameter as the plug pin 27. In addition, the contact pin 49—irrespective of its diameter—may be part of the plug pin 27, i.e., be connected in one piece in a seamless manner with said plug pin. It may also be manufactured as a separate element and be attached to the plug pin 27.

The contact arrangement 48, for example in the embodiment of the contact pin 49, is preferably made of metal or is at least metallized on parts of the surface. The thusly formed electrically conductive surface is in electrical connection with the line 42. The plug pin 27 itself may consist of metal and thus establish the electrical contact between the line 42 and the contact pin 49. It is also possible to make the plug pin 27 of electrically non-conductive material, for example of plastic material, and to pass the electrical line 42 through a not specifically illustrated axial channel of the plug pin 27 up to the contact pin 49 in order to provide a contact therewith. The line 49 may extend in insulated or exposed form through the body of the plug pin 27 and, if said plug pin consists of a plastic material, be embedded therein.

The contact arrangement 48 on the plug side is associated with a contact arrangement 51 on the socket side, said contact arrangement 51 being arranged on the inner end of the female connector 45 or the fluid connector element 33. The contact arrangement 51 may be configured as the female contact connector 52, into which the contact pin 49 is to be plugged. The female contact connector 52 may consist of metal or any other conductive material. In its interior—that is cylindrical, for example—there can be arranged two or more contact means 53, 54 whose two ends abut against the inside wall of the female contact connector 52 and bow toward the contact pin 49 in order to be in resilient contact with said pin. The female contact connector 52 provides the electrical contact to the electrical line 39. It is also possible to make the female contact connector 52 of a non-conductive material and to connect the line 39 in another manner to the contact means 53, 54.

As can be seen, the fluid channel 36 leads essentially radially to an opening 55 in the wall of the female plug connector 45. An opening 56 is provided in the same or a similar axial position, said opening leading to a section of the fluid channel 30 extending in a radial direction or extending otherwise in a direction transverse to the axis 50. Viewed in axial direction, gaskets 57, 58 are provided on the plug pin 27 upstream and downstream of the opening 56 as well as of the opening 55 (with the plug pin 27 plugged in). These may be, for example, O-rings 57, 58 seated in corresponding annular grooves, said gaskets delimiting an intermediate space 59 that is fluid tight and in communication with the fluid channels 30, 36.

The plug and socket connector comprising the two plug and socket connector parts 15, 17 in one approach works in accord with the following description. The plug 16 is manually plugged into or pulled out of the socket 18, for example, in that the plug 16 is plugged into or pulled out of the socket 18 in the axial direction of the plug pins 27-29, said axial direction being defined by axis 50. When the plug pins 27-29 are plugged into the female connectors 45-47, said pins find their way into the sockets. In doing so, the O-rings 57, 58 or any other gaskets slide along the inside wall of the socket 45-47, In doing so, the O-ring 57 that is positioned closer to the free end of the plug pin 27-29 moves over the opening 55, while the other O-ring 58 does not reach said opening. Just before the end of the plug-in movement, preferably after the opening 55 is already positioned between the two O-rings 57, 58, the contact arrangement 48 comes into operative connection with the contact arrangement 51. Expressed in general terms this means that—only after establishing the reliable outwardly tight fluid connection between the fluid channels 30, 36—the electrical contact is established between the contact arrangements 48, 51 when the fluid connector element 24 is plugged into the fluid connector element 33. Thus, when plugging-in, the electrical contact connection is downstream and, when unplugging, said contact connection is upstream. Consequently, the electrical contact may, at the same time, act as an indicator that shows that the fluid connector connection has been established correctly. Thus, an escape of gasses is precluded, in particular when these are subject to high pressure.

Any fluid can be conveyed at a high flow rate and/or at high pressure through the fluid channels 30, 36. Electrical signals can be conveyed for the transmission of information or power via the contact arrangements 48, 51.

Numerous modifications of the previously described embodiment of the plug and socket connector parts 15, 17 and their components are possible, in which case said modifications can be attached to a single or to all connector elements 24 through 26, as well as 33 through 35.

As shown by FIG. 5, for example, the allocation of the electrical contact pin 49 and the female contact connector 51 to the fluid connector elements 24, 33 can be reversed. There, the contact pin 49 is arranged at the bottom of the female connector 45, whereas the contact arrangement 51 and its female contact connector 52 are arranged in a face-side recess of the fluid connector element 24, i.e., the plug pin 27.

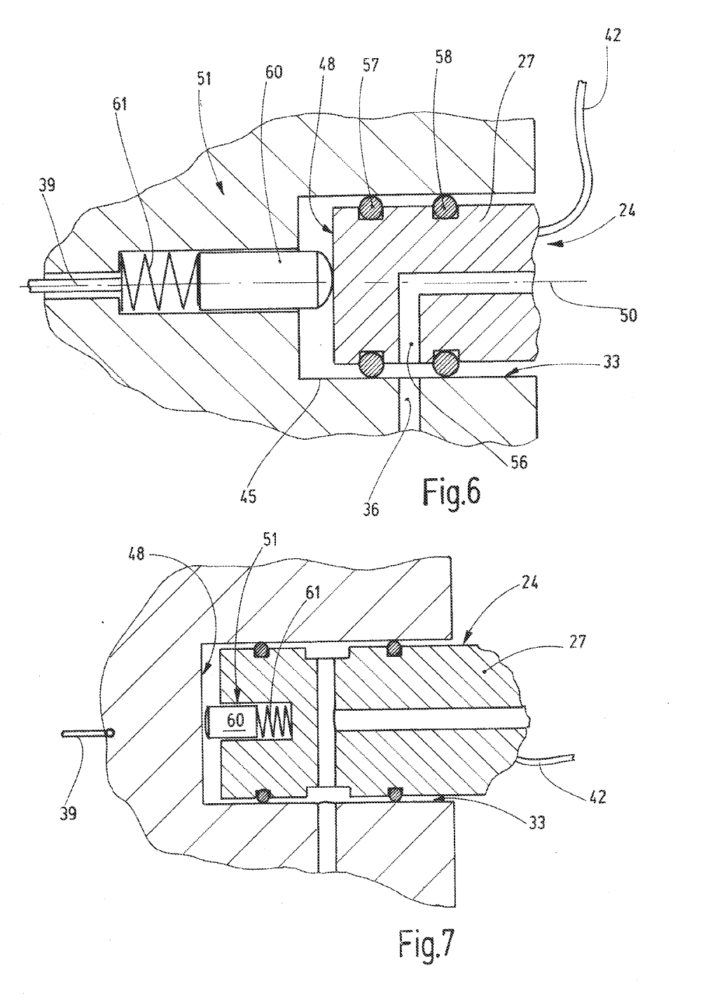

Additional modifications are possible, such as those shown in FIG. 6 based on the previous description. Components that have the same design or function are identified by the same reference signs without renewed explanation. In this case, e.g., the—plane or also differently shaped—face surface of the plug pin 27 acts as the contact arrangement 48 on the plug side. In this case, the contact arrangement 51 on the female connector side is a contact pin 60 that can be supported so as to be movable in axial direction along axis 50 and may be pretensioned by a means 61, for example, a spring 61, toward the plug pin 27. Preferably, the contact pin 60 is essentially cylindrical. Its diameter may be smaller, be the same or be greater than the diameter of the plug pin 27. Preferably, the face surface of the contact pin 60 that is intended for contact is plane or curved. The spring 61 can establish the electrical contact between the line 39 and the contact pin 60. The line 39 may also be directly connected to the contact pin 60.

As is shown by FIG. 7, it is again possible to reverse the allocation of the two contact arrangements 48, 51 to the fluid connector elements 24, 33. In this case, electrical contacting is particularly simple. The line 39 can be connected to the body of the fluid connector element 33, while the contact pin 60 is seated in the preferably electrically conductive body of the plug pin 27 or is in contact therewith due to the means 61. Again, the line 42 adjoins the plug pin 27.

It is pointed out that, in particular for the transportation of fluids that are only minimally pressurized or subjected to a vacuum, the use of fluid channels 30-32 that terminate on the face side of the plug pin 27-29 is also possible. This is applicable to all embodiments. Then, a single gasket, e.g., an O-ring 57, is sufficient to create a seal.

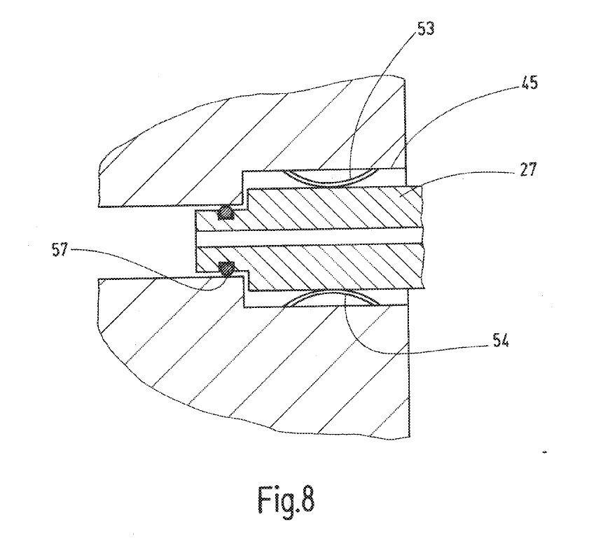

FIG. 8 shows an example of such an embodiment. Reference is made to the previous description based on the previously introduced reference signs. As illustrated, it is possible to use a stepped or also a non-stepped plug pin 27. The contact means 53, 54, e.g., configured as one or more spring contacts abutting against one or both ends, are preferably arranged near the open end of the female connector 45. Preferably, the gasket 57 is arranged at the distal end of the plug pin 27, said pin having a diameter that is at least preferably smaller than the diameter of the remaining plug pin 27. With the components plugged in, the fluid contact is preferably downstream and the electrical contact upstream, whereas with the components unplugged, this arrangement is active in reverse order.

A plug and socket connector system in accordance with the invention for use, in particular, in medical technology comprises a plug 16 and a socket 18, wherein each of the two comprises at least one fluid connector element 24, 33. The fluid connector elements 24, 33 are provided with electrical contact arrangements 48, 51, thus providing a space-saving, robust and safe system.

### LIST OF REFERENCE SIGNS

10 Medical device
11 Surgical instrument
12 Grip part
13 Part
14 Line
15 Plug and socket connector part
16 Plug
17 Plug and socket connector part
18 Socket
19 Jacket sheath
20-22 Tubes, hoses
23 Electric line
24-26 Fluid connector elements
27-29 Plug pins
30-32 Fluid channels (31a)
33-35 Fluid connector elements
36-38 Fluid channels (37a)
39-44 Electric lines
45-47 Female connectors
48 Contact arrangement
49 Contact pin
50 Axis
51 Contact arrangement
52 Female contact connector
53, 54 Contact means
55, 56 Openings
57, 58 Gaskets
59 Intermediate space
60 Contact pin
61 Means, spring

What is claimed is:

1. Plug and socket connector part (15) in the form of a plug (16) for a medical device (10) or for a surgical instrument (11), comprising
at least one fluid connector element (24) configured as a plug pin (27) comprising
at least one fluid channel (30) which communicates with an opening (56) provided on the plug pin (27), and
on which an electrical contact arrangement (48) is provided.

2. Plug and socket connector part (17) in the form of a socket (18) for a medical device (10) or for a surgical instrument (11), comprising
at least one fluid connector element (33) configured as a female connector (45) comprising
at least one fluid channel (36) which communicates with an opening (55) provided in the female connector (45) and
in which an electrical contact arrangement (51) is provided.

3. Plug and socket connector arrangement as in one of the previous claims, characterized in that the electrical contact arrangement (48, 51) and the fluid connector element (24, 33) are arranged so as to be coaxial to each other.

4. Plug and socket connector arrangement as in one of the previous claims, characterized in that the electrical contact arrangement (48, 51) and the fluid connector element (24, 33) are electrically connected to each other.

5. Plug and socket connector arrangement as in one of the previous claims, characterized in that the electrical contact arrangement (48, 51) and the fluid connector element (24, 33) are electrically insulated from. each other.

6. Plug and socket connector arrangement as in one of the previous claims, characterized in that an electrical line (39, 42) is connected to the contact arrangement (48, 51) and/or to the fluid connector element (24, 33).

7. Plug and socket connector arrangement as in one of the previous claims, characterized in that the electrical contact arrangement (48, 51) is monopolar.

8. Plug and socket connector arrangement as in one of the previous claims, characterized in that the electrical contact arrangement (51) is a female contact connector (52).

9. Plug and socket connector arrangement as in claim 8, characterized in that the female contact connector (52) comprises at least one spring contact (53).

10. Plug and socket connector arrangement as in one of the previous claims, characterized in that the electrical contact arrangement (48) is an axially oriented contact surface.

11. Plug and socket connector arrangement as in one of the previous claims, characterized in that the electrical contact arrangement (48, 51) is a contact pin (49, 60).

12. Plug and socket connector arrangement as in claim 111, characterized in that the contact pin (49, 60) is rigidly or resiliently supported.

13. Plug and socket connector arrangement as in one of the previous claims, characterized in that the fluid channel (30, 36) has, adjoining the opening (55, 56), a section extending transversely to the axial direction.

14. Plug and socket connector arrangement as in claim 13, characterized in that a gasket (57, 58) is arranged upstream and downstream of the opening (56).

15. Plug and socket connector arrangement as in one of the previous claims, characterized in that electrical contact arrangement (48, 51) is configured, relative to the fluid connector element (27, 33), so as to be contacting downstream when the fluid connector is being closed and so as to be electrically opening upstream when the fluid connector is being opened.
